(19) United States
(12) Patent Application Publication
(10) Pub. No.: US 2011/0287743 A1
(43) Pub. Date: Nov. 24, 2011

(54) Method, system and user equipment for establishing association between a service network element and an MME

(75) Inventors: Ying Hu, Shenzhen (CN); Zaifeng Zong, Shenzhen (CN)

(73) Assignee: ZTE CORPORATION, Shenzhen, Guangdong (CN)

(21) Appl. No.: 13/144,772

(22) PCT Filed: Dec. 21, 2009
(86) PCT No.: PCT/CN2009/075792

§ 371 Date: Jul. 15, 2011

(30) Foreign Application Priority Data
Jan. 16, 2009 (CN) 200910105097.1

(51) Int. Cl. H04W 60/00; H04W 12/06

(52) U.S. Cl. 455/411; 455/435.1

(57) ABSTRACT

The present invention provides a method, system and UE for establishing association between a service network element and an MME, in order to solve the technical problem of establishing association between the service network element and the MME. The technical solution of the present invention is as follows: the service network element receives a message sent by the UE including an information parameter of the MME which is currently serving the UE, and acquires the information parameter of the MME from the message; the service network element sends a message including an information parameter of the service network element to the MME; and the MME acquires the information parameter of the service network element from the message. The present invention realizes the requirement of establishing association between the service network element and the MME without modifying and upgrading network elements related to the PCC architecture for implementing the function, reduces the operating cost and risk of the existing network, and favours the prompt application of the EPS network.

### TECHNICAL FIELD

The present invention relates to the field of mobile communications, in particular to a method, system and User Equipment (UE) for establishing association between a service network element and an MME when the UE accesses an Evolved Packet System (EPS) network to implement a service.

### BACKGROUND

The 3rd Generation Partnership Project (3GPP) is committed to studying the evolution of Packet Switched Core (PS Core) network and Universal Mobile Telecommunication System Radio Access Network (UTRAN) at present in order to maintain strong competitiveness in the field of mobile communications, make it possible for an Evolved PS Core (EPC) to provide higher transmission rate and shorter transmission delay, and support the mobility management among Evolved UTRAN (E-UTRAN), GSM EDGE Radio Access Network (GERAN, wherein GSM is short for Global System for Mobile communications and EDGE is short for Enhanced Data Rate for GSM Evolution), UTRAN, Wireless Local Area Network (WLAN) and other non-3GPP access networks. The evolved mobile communication system is called the Evolved Packet System (EPS).

FIG. 1 shows a diagram of a network architecture to implement a Circuit Switch (CS) service when a UE accesses an EPS network in the prior art, and each entity in FIG. 1 is described as follows:

a UE, in the present invention, represents various terminals;

an E-UTRAN, which is an evolved radio access network and can provide higher uplink and downlink speeds, lower transmission delay and more reliable radio transmission; the network element contained in the E-UTRAN is evolved NodeB (eNodeB) and provides radio resources for the accessing of the UE;

a Serving GateWay (S-GW), which is an user plane entity and in charge of the user plane data routing processing;

a Packet Data Network GateWay (PDN GW or P-GW), which is in charge of the gateway function of a Packet Data Network (PDN) which the UE accesses; the P-GW and the S-GW may be arranged in one physical entity;

a Mobility Management Entity (MME), which is a control plane entity and a server for temporarily storing data of a subscriber, and is in charge of managing and storing UE context, such as a UE/subscriber identity, a mobility management state, a subscriber security parameter and the like, distributing temporary identity for a subscriber, and authenticating the subscriber when the UE currently camps in the tracking area or the network managed by the MME;

a Globally Unique Temporary UE Identity (GUTI), which is used for providing an unambiguous identification for a UE in the EPS network without revealing the permanent identity information of the subscriber or the UE, and consists of two parts which are a Globally Unique MME Identifier (GUMMEI) of an MME and an M-Temporary Mobile Subscriber Identity (M-TMSI) of the UE in the MME; wherein the GUMMEI is used for uniquely identifying the MME and the network which allocate the GUTI, and is the globally unique identifier of the MME, and the GUMMEI consists of a Mobile Country Code (MCC), a Mobile Network Code (MNC) and an MME Identifier (MMEI), wherein the MMEI consists of an MME Group ID (MMEGI) and an MME Code (MMEC); the M-TMSI is a temporary identity of a UE allocated by the MME when the UE accesses the MME, only the MME and the UE know the corresponding relationship between an International Mobile Subscriber Identity (IMSI) and the M-TMSI;

when the UE performs Attach or Tracking Area Update (TAU, the process that the UE updates location in the EPS network) in the EPS network, the access (Attach or Tracking Area Update) acceptance message sent from the MME to the UE includes the GUTI allocated by the MME to the UE and the UE receives the GUTI and stores it;

a GERAN/UTRAN, which is the radio access network of a GSM/Universal Mobile Telecommunications System (UMTS) network; and

a Mobile Switching Center (MSC)/Visitor Location Register (VLR), which can be a new functional entity MSC server since the R4 period and is uniformly represented by MSC/VLR in the present invention, the MSC and the VLR which are two logically separated units are generally a combined physical node during the actual implementation and deployment.

When the UE accesses the GSM/UMTS network, a basic voice service, a supplementary service based on the voice service and other services of the subscriber are provided by the Circuit Switch (CS) domain (called as circuit domain hereinafter); the MSC/VLR in FIG. 1 is the CS domain network element, and the subscriber can perform CS services, such as voice calls, with the users in this network and other networks (such as fixed telephone networks and other mobile networks) through the CS domain.

The EPS system per se cannot provide and control the CS services, such as a voice call, and can only provide the bearer for Internet Protocol (IP) data; a method for implementing the CS services, such as voice call in the prior art when the UE accesses the EPS network is that the CS services are controlled and implemented by the CS domain; and after the UE accesses the EPS network, the interaction signalling between the UE and the MSC/VLR is transmitted via an IP signalling channel borne on the EPS network to perform interaction procedures, such as location area update and call, and voice media streams are transmitted by an IP user plane channel borne on the EPS network. The IWF in FIG. 1 can be various network element with corresponding functions which is uniformly represented by the IWF in the present invention.

FIG. 1 shows the network architecture of the solution in the prior art to implement the CS services, such as voice, via controlled by the CS domain, when a UE accesses an EPS network; in the solution, in order to avoid modifying and affecting the MSC/VLR, an InterWorking Function (IWF) is newly introduced to complete the related modifications, the IWF behaves like a BSC/RNC towards the MSC/VLR, providing an A/IU-CS interface, converting an IP signalling message received from the UE into an A/IU-CS interface message and sending the converted A/IU-CS interface message to the MSC/VLR, and completing the conversion and sending in the reverse direction. After accessing the EPS network, the UE interacts with the IWF and MSC/VLR to perform the interaction procedures, such as registration, location area update and voice calls, through the IP signalling channel borne on the EPS network so as to complete the bear creating procedure and call setup procedure. When the UE needs to handover from the EPS network to the UMTS/GSM network and the MME receives a handover request, for the voice service, the MME needs to send a handover request message to the IWF which is currently serving the UE, so that the IWF can convert the handover request message and sends the handover request message to the MSC/VLR currently controlling the call; therefore, the MME which is currently serving the UE needs to know the information of IWF which is currently serving the UE.

A solution for solving the above mentioned problem may be: in the procedure of setting up a bearer for voice call, by modifying the Policy Control and Charging (PCC) mechanism, the IWF is allowed to transmit information to the MME through the PCC mechanism in the creating procedure of the voice bearer, so it is required to modify the network elements related to the PCC, such as Policy Charging Rule Function (PCRF), P-GW and S-GW.

Another solution which may be implemented is that the MME query an external database or a server storing the information of the IWF which is currently serving the UE, and in this solution, it is required to add interfaces and the like between the MME and the external database or the server.

For the two solutions above, it is required to modify and upgrade lots of network elements, such as the PCRF, which are not related to the function, thereby the design cost and implementation cost are certainly very high, and operating cost and risk of the network are also increased accordingly.

In addition, the related service network elements may also need to establish association with the MME when the UE accesses the EPS network to implement other services besides CS services, such as the voice.

Therefore, to sum up, it is required to provide a method for establishing association between a service network element which is currently serving the UE and the MME without modifying and upgrading the network elements which are not related to the function, such as the PCRF.

### SUMMARY

Based on the above problem, the present invention aims to provide a method, system and UE for establishing association between a service network element and an MME when the UE accesses an EPS network to implement a service, so as to solve the problem of establishing association between the service network element and the MME without modifying the network elements which are not related to the function, such as the PCRF for implementing the function.

To achieve the objective, the present invention adopts the following technical solutions:

a method for establishing association between a service network element and an MME is applied to a scenario when a UE accesses an EPS network and the service network element needs to establish association with the MME, the method comprises:

the service network element receives a message sent by the UE including an information parameter of the MME which is currently serving the UE; and

the service network element acquires the information parameter of the MME which is currently serving the UE from the message sent by the UE so as to establish association between the service network element and the MME which is currently serving the UE.

Further, after the service network element acquires the information parameter of the MME, the method may further comprise: the service network element sends a message including an information parameter of the service network element to the MME; and the MME receives the message sent by the service network element including the information parameter of the service network element, and acquires the information parameter of the service network element from the message.

Further, the information parameter of the MME may be Globally Unique Temporary UE Identity (GUTI) or identifier information of the MME acquired according to the GUTI.

Further, when the message sent from the UE to the service network element is a service registration request message, the service network element may send a message including the information parameter of the service network element to the MME when the service network element receives the service registration request message from the UE or in a service implementing procedure.

Further, after the association between the service network element and the MME is established, if there is a change with the MME, the method may further comprise: after receiving an allocated GUTI from the MME which is newly serving the UE, the UE triggers a new registration flow to the service network element to update the association between the service network element and the MME which is newly serving the UE; or the MME which is newly serving the UE allocates GUTI to the UE and instructs the UE to trigger a new registration flow to the service network element to update the association between the service network element and the MME which is newly serving the UE.

Further, after the association between the service network element and the MME is established, if there is a change with the MME, the method may further comprise: information of the service network element is transmitted among MMEs, the MME which is newly serving the UE acquires and updates the information of the service network element; and/or the MME which is newly serving the UE sends a message to the service network element to update the information of the MME stored in the service network element after acquiring the information of the service network element; or after receiving an allocated GUTI from the MME which is newly serving the UE, the UE triggers a new registration flow to the service network element to update the association between the service network element and the MME which is newly serving the UE; or the MME which is newly serving the UE allocates GUTI to the UE and instructs the UE to trigger a new registration flow to the service network element to update the association between the service network element and the MME which is newly serving the UE.

Further, after the association between the service network element and the MME is established, if there is a change with the service network element, the method may further comprise: a new service network element acquires the information parameter of the MME from the old service network element, and sends a message to the MME to update the information parameter of the service network element stored in the MME to the information parameter of the new service network element; or the UE initiates a new registration procedure to update the association between the new service network element and the MME which is serving the UE.

Further, the service network element may be an IWF; the message sent from the UE to the IWF may be a registration request message or an update message; the message sent from the IWF to the MME including the information parameter of the service network element may be a registration request message, or a message for requesting to authenticate the validity of the UE, or a message for requesting to register the IWF as a handover anchor point for voice service.

Based on the method, the present invention further provides a system for establishing association between a service network element and an MME, the system comprises the MME and the service network element, wherein

the service network element is configured to receive a message sent by the UE including an information parameter of the MME which is currently serving the UE, and acquire the information parameter of the MME from the message so as to establish association between the service network element and the MME which is currently serving the UE.

Besides, the service network element may be further configured to send a message including an information parameter of the service network element to the MME; and the MME may be configured to receive the message sent by the service network element including the information parameter of the service network element, and acquire the information parameter of the service network element from the message.

Moreover, the service network element may specifically comprise: a receiving unit, an information acquiring unit and a sending unit; wherein

the receiving unit may be configured to receive the message sent by the UE including the information parameter of the MME which is currently serving the UE;

the information acquiring unit may be configured to acquire the information parameter of the MME; and

the sending unit may be configured to send the message including the information parameter of the service network element to the MME.

Further, the service network element may be an IWF.

In addition, the UE is configured to send to a service network element a message including an information parameter of an MME which is currently serving the UE.

Compared with the prior art, the method of the present invention realizes the requirement of acquiring the MME information and establishing association between the IWF, as well as the service module, and the MME without modifying and upgrading network elements related to the PCC architecture for implementing the function, reduces the operating cost and risk of the existing network and favours the prompt application of the EPS network.

### BRIEF DESCRIPTION OF THE DRAWINGS

FIG. 1 shows a diagram of a network architecture to implement a CS service when a UE accesses an EPS network in the prior art;

FIG. 2 is a schematic flowchart of the method in the present invention;

FIG. 3 is a schematic flowchart of the method according to the first embodiment of the present invention;

FIG. 4 is a schematic flowchart of the method according to the second embodiment of the present invention;

FIG. 5 is a schematic flowchart of the method according to the third embodiment of the present invention;

FIG. 6 is a schematic flowchart of the method according to the fourth embodiment of the present invention; and

FIG. 7 is a schematic diagram of the structure of the system according to the fifth embodiment of the present invention.

### DETAILED DESCRIPTION

The method for establishing association between a service network element which the UE accesses via the EPS network and an MME is further described in detail below in combination with the drawings.

The service network element in the present invention refers to that: the UE accesses the network element via the EPS network and the network element needs to interact with the MME to complete some service functions. For example, the IWF which implements the CS service when the UE accesses the EPS network to complete the CS service is a service network element of the present invention.

Establishing association between the service network element and the MME refers to that: the service network element acquires the information of the MME and the MME acquires the information of the service network element; or the service network element acquires the information of the MME; or the MME acquires the information of the service network element.

After accessing the EPS network, the UE stores the GUTI information and can acquire the information of the MME which is currently serving the UE according to the GUTI; so in the method provided by the present invention that is different from the method in which the information of the service network element is acquired by the MME, the information of the MME which is currently serving the UE is acquired by the service network element at first, and then the service network element sends a message to the MME, so that the MME can acquire the information of the service network element which is currently serving the UE and in addition, with the method, there is only impacts on new interfaces among the UE, the service network element and the MME, and the modification causes little influence.

The present invention provides a universal method for implementing the establishment association between a service network element and an MME, the method is used to implement some services, such as handover of CS voice calls, when the UE accesses the EPS network; the method comprises: the GUTI of the UE which currently accesses the EPS network or the identifier information of the MME acquired according to the GUTI of the UE which currently accesses the EPS network, is sent to a service network element when the UE sends a message to the service network element to perform registration and other procedures; and the service network element acquires the information of the MME which is currently serving the UE according to the GUTI information or the identifier of the MME; then by sending a message to the MME the service network element establishes association with the MME (the MME acquires the information of the service network element and the service network element acquires the information of the MME). Subsequently, if the service network element or the MME is changed due to the moving of the UE or the like, when there is a change with the service network element or the MME, a new service network element and/or the MME updates association information stored.

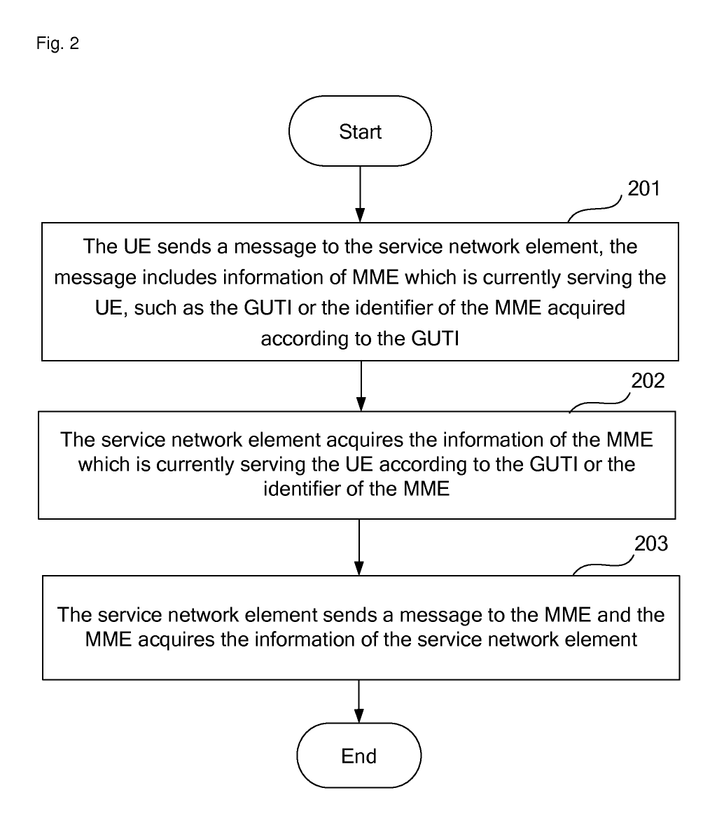

The flow of the method of the present invention is shown in FIG. 2:

201: the UE sends a message to the service network element, the message including information representing the information parameter of the MME which is currently serving the UE, such as the GUTI, or the identifier information of the MME acquired according to the GUTI;

202: the service network element acquires the information of the MME which is currently serving the UE according to the GUTI or the identifier of the MME; and

203: the service network element sends a message including the information parameter of the service network element to the MME, thus the MME acquires the information of the service network element, since then, the association between the MME and the service network element is established.

Afterwards, when there is a change with the service network element or the MME, the new service network element and/or the MME updates the association information stored. There are multiple specific implementing methods for updating association information, and one or any combination and changed modes of the following embodiments can be adopted as required for specific implementation.

In a preferred embodiment of the present invention, when the MME is changed due to the moving of the UE or network load adjustment or other reasons, the association information stored in the service network element and/or the MME is updated by the following ways:

1. the information of the service network element is transmitted among MMEs, and the MME which is newly serving the UE acquires and updates the information of the service network element stored; and/or the MME which is newly serving the UE sends a message to the service network element to update the information of the MME stored in the service network element after acquiring the information of the service network element;

2. after receiving an allocated GUTI from the MME which is newly serving the UE, the UE triggers a new registration flow to the service network element to update the association between the service network element and the MME which is newly serving the UE according to the flow or partial flow in FIG. 2;

3. the MME which is newly serving the UE allocates the GUTI to the UE, and instructs the UE to trigger a new registration flow to the service network element to update the association between the service network element and the MME which is newly serving the UE according to the flow or partial flow in FIG. 2.

In a preferred embodiment of the present invention, when the service network element is changed due to the moving of the UE or network load adjustment or other reasons, the association information stored in the service network element and/or the MME is updated by the following ways:

1. the new service network element acquires from the old service network element the information of the MME, such as GUTI or the identifier of the MME, then the new service network element acquires the information of the MME according to these information and then sends a message to the MME to update the association information stored in the MME to the information of the new service network element;

2. the UE initiates a new registration procedure and updates the association between the new service network element and the MME which is serving the UE according to the flow or partial flow in FIG. 2.

Before the method is implemented, the following procedure is performed: the UE accesses the EPS network at first, the UE sends an Attach or Tracking Area Update request to the MME; the MME, the UE and other network elements perform corresponding interaction and processing with one another; the GUTI is included in the Attach or Tracking Area Update request acceptance message sent from the MME to the UE; and the UE receives the message and stores the GUTI.

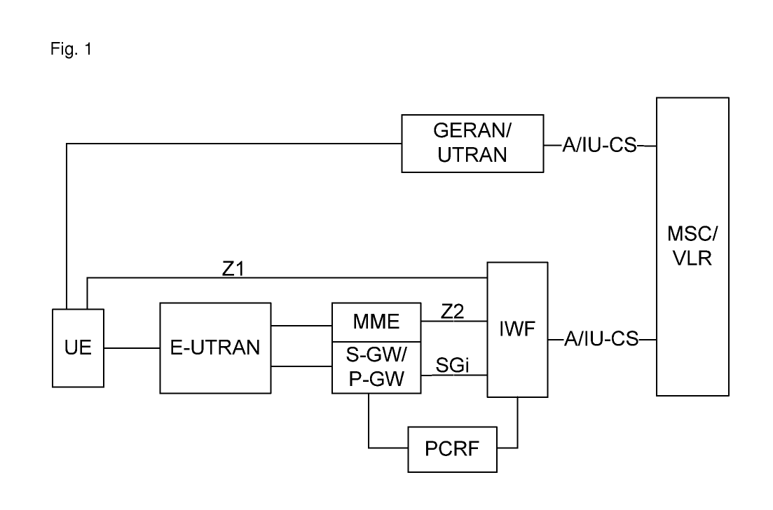

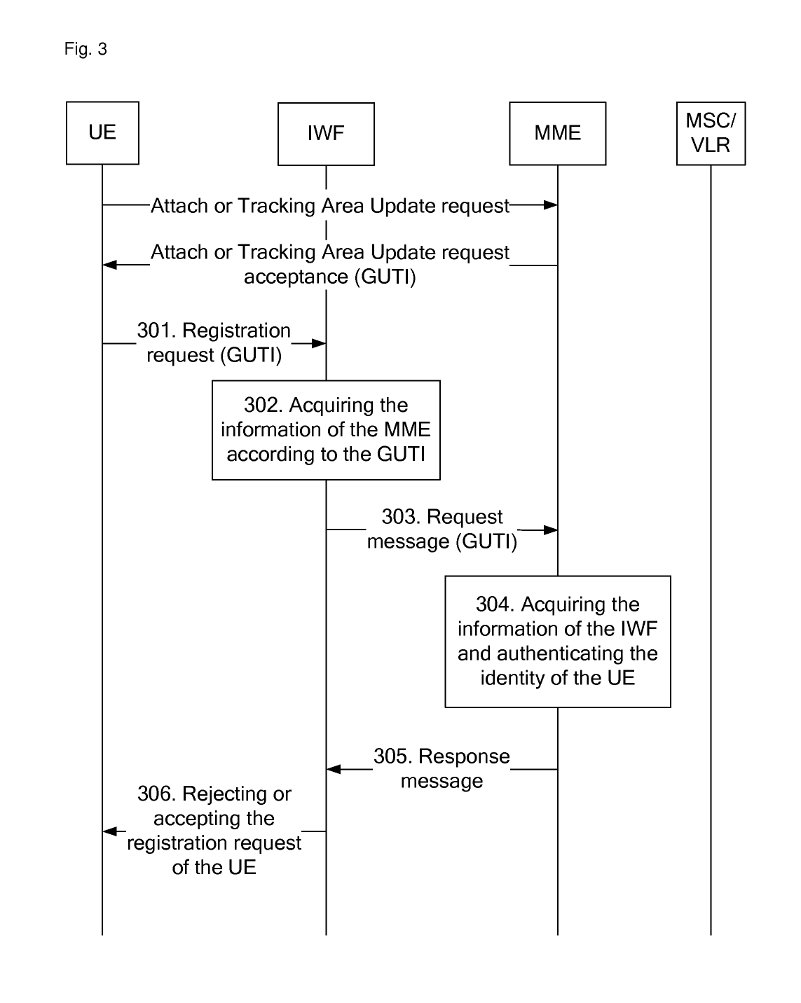

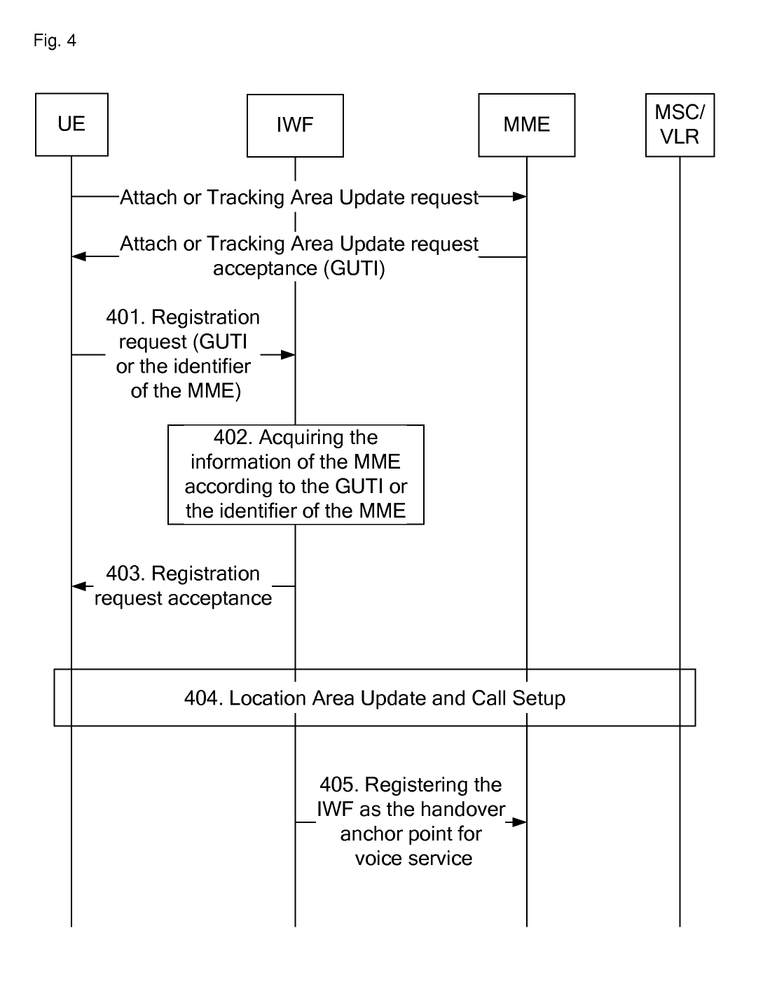

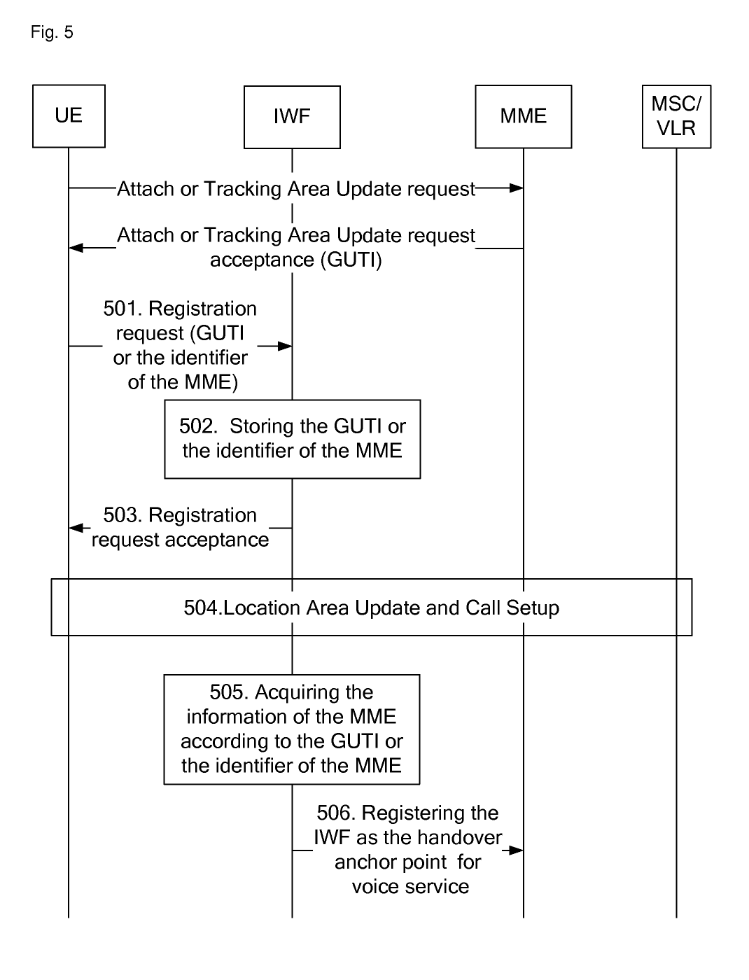

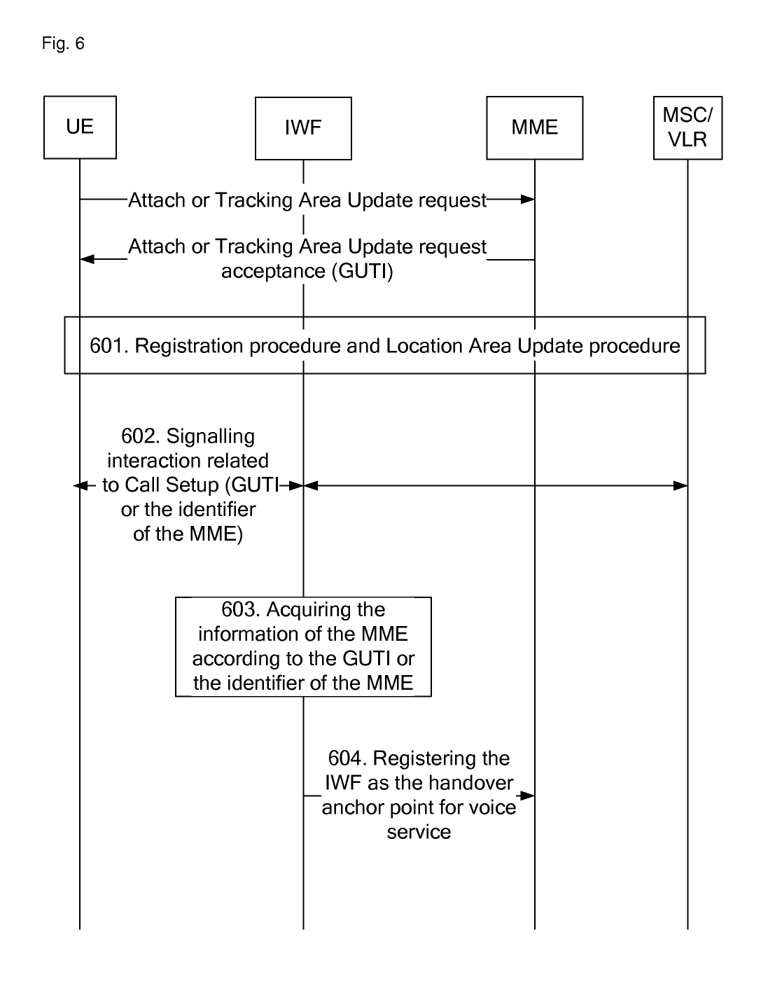

The method of the present invention may have multiple implementation flows. Four implementation flows are described in detail below in combination with the drawings. FIG. 3, FIG. 4, FIG. 5 and FIG. 6 respectively show the four possible implementation flows of the method applied to the architecture as shown in FIG. 1. In the implementation flows, the service network element is the IWF as shown in FIG. 1.

### First Embodiment

FIG. 3 is a schematic flowchart of the method according to the first embodiment of the present invention; as shown in FIG. 3, when the service network element is the IWF, the method may be the following flow:

step 301: the UE sends a registration request message to the IWF, wherein the message includes the GUTI information, or includes all or partial of the following parameters:

the location information of the UE in the EPS network, such as Tracking Area Identity (TAI), E-UTRAN Cell Global Identifier (E-CGI), or TAI and E-CGI, IMSI, GUTI, the IP address(es) of the UE;

step 302: the IWF acquires the information of the MME, such as the address information of the MME, according to the GUTI, and stores or does not store the information of the MME;

step 303: the IWF sends a message to the MME, wherein the message may be sent at multiple moments and by multiple implementation ways during implementation, one of the implement instances is as show in the flow in FIG. 3, the IWF sends the MME a message for requesting registration and authentication of the validity of the UE; the message includes the GUTI information, the location information of the UE in the EPS network, all or partial of the information of the IMSI, IP address(es) of the UE, the address of the IWF; and the IWF requests the MME to perform identity authentication of the UE, such as the validity authentication;

step 304: the MME receives the message, acquires the information of the IWF, such as the address of the IWF, and stores or does not store the information; since then, the MME have acquired the information of the IWF which is currently serving the UE; the MME authenticates the identity of the UE, for example, according to the information stored in the MME, the MME can check whether the GUTI is valid, whether the corresponding relationship between the GUTI and the IMSI in the registration request message sent by the UE is consistent with the corresponding relationship stored in the MME, or whether the corresponding relationship between the GUTI and the IP address of the UE is consistent with the corresponding relationship stored in the MME, or whether the corresponding relationship between the IMSI and the IP address of the UE is consistent with the corresponding relationship stored in the MME, or whether the IP address of the UE is valid, or various combinations of the above determining methods and conditions and so on;

step 305: the MME sends a response message to the IWF, wherein the message may include the information indicating whether the UE is valid and other information;

step 306: the IWF sends a message to the UE, and rejects or accepts the registration request from the UE.

In the embodiment, the IWF may also not require the MME to authenticate the identity of the UE, and the parameters and processing are different correspondingly.

In the embodiment, the message sent from the UE to the IWF may not include the GUTI but the information related to the identifier of the MME and the user. The IWF acquires the information of the MME according to the identifier information of the MME and performs the corresponding processing.

In the implementing method of the embodiment, besides identity authentication of the UE is implemented by the interaction between the IWF and the MME, the following function can also be completed: when the UE does not perform a voice service, the IWF can interact with the MME through the acquired information and perform corresponding services. For example, the IWF receives related messages from the MSC/VLR, needs to acquire the current location information of the UE in the EPS network from the MME to implement the location service and so on; and the IWF can send a message to the MME which is currently serving the UE according to the acquired information of the MME to perform interaction and thereby acquire the location information. Or in the call setup procedure of the UE, the IWF queries the current location information of the UE and other information from the MME via the interface.

### Second Embodiment

FIG. 4 is the schematic flowchart of the method according to the second embodiment of the present invention:

step 401: after accessing the EPS network, the UE sends a registration request message to the IWF, wherein the message includes the GUTI or the identifier of the MME acquired according to the GUTI;

step 402: the IWF acquires the information of the MME according to the GUTI or the identifier of the MME and stores it;

step 403: the IWF sends a registration request acceptance message to the UE;

step 404: the UE, IWF and MSC interact with one another to perform the location area update procedure and call setup procedure;

step 405: in or after the call setup procedure, the IWF sends to the MME a message for requesting to register the IWF as the handover anchor point for the voice service; the IWF is registered as the handover anchor point for the voice service; and the message includes the information parameter of the IWF; since then, the MME acquires the information of the IWF which is currently serving the UE; and during the handover procedure, the MME can send the handover request message to the IWF.

### Third Embodiment

FIG. 5 is the schematic flowchart of the method according to the third embodiment of the present invention:

step 501: the UE sends a registration request message to the IWF, wherein the message includes the GUTI or the acquired identifier of the MME which is currently serving the UE according to the GUTI;

step 502: the IWF receives the message and stores the GUTI or the identifier of the MME;

step 503: the IWF returns a registration request acceptance message to the UE;

step 504: the UE, IWF and MSC interact with one another to perform the location area update procedure and call setup procedure;

step 505: in or after the call setup procedure, the IWF acquires the information of the MME according to the GUTI or the identifier of the MME;

step 506: in or after the call setup procedure, the IWF sends to the MME a message including the information parameter of the IWF for requesting to register the IWF as the handover anchor point for the voice service; the IWF is registered as the handover anchor point for the voice service; since then, the MME acquires the information of the IWF which is currently serving the UE; and during the handover procedure, the MME can send the handover request message to the IWF.

### Fourth Embodiment

FIG. 6 is the schematic flowchart of the method according to the fourth embodiment of the present invention:

step 601: the UE, IWF and MSC interact with one another to perform the UE registration in the IWF and perform location area update in the MSC/VLR;

step 602: the UE, IWF and MSC perform signalling interaction related to call setup procedure with one another; and the message from the UE to the IWF including the GUTI or the identifier of the MME acquired according to the GUTI;

step 603: in or after the call setup procedure, the IWF acquires the information of the MME according to the GUTI or the identifier of the MME;

step 604: in or after the call setup procedure, according to the acquired information of the MME, the IWF sends a message to the MME which is serving the UE to request to register the IWF as the handover anchor point for the voice service; the IWF is registered as the handover anchor point for the voice service; and the message includes the information parameter of the IWF; since then, the MME acquires the information of the IWF which is currently serving the UE; and during the handover procedure, the MME can send the handover request message to the IWF.

### Fifth Embodiment

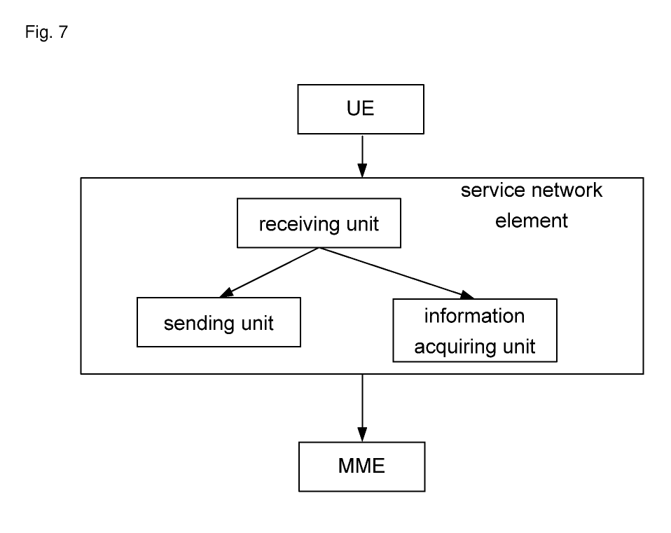

The present invention provides a system for establishing association between a service network element and an MME, and FIG. 7 is a schematic diagram of the structure of the system in the present invention. As shown in FIG. 7, the system provided in the present invention comprises:

a service network element configured to receive a message sent by the UE including the information parameter of the MME which is currently serving the UE, acquire the information parameter of the MME included in the message and send a message including the information parameter of the service network element to the MME; and

an MME configured to receive a message sent by the service network element including the information parameter of the service network element, and acquire the information parameter of the service network element.

Moreover, the service network element specifically comprises:

a receiving unit configured to receive the message sent by the UE including the information parameter of the MME which is currently serving the UE;

an information acquiring unit configured to acquire the information parameter of the MME; and

a sending unit configured to send a message including the information parameter of the service network element to the MME.

Moreover, the service network element is an IWF.

### Sixth Embodiment

The present invention further provides a User Equipment (UE), the UE sends to the service network element a message including the information parameter of the MME which is currently serving the UE.

To sum up, the method of the present invention realizes the requirement of establishing association between the IWF, as well as other service modules and the MME so as to handover a voice bearer and acquiring location information from the MME and the like functions without modifying and upgrading network elements related to the PCC architecture (such as PCRF, S-GW and P-GW) for implementing the functions, reduces the operating cost and risk of the network and favours the prompt application of the EPS network.

Obviously, those skilled in the art should understand that the above modules or steps of the present invention may be implemented by general computing devices, and they may be centralized in a single computing device or distributed in a network consisting of multiple computing devices. Optionally, the modules or steps may be implemented by program codes executable to the computing devices, so that they may be stored in a storage device and executed by the computing device, or respectively made into respective integrated circuit modules, or some of modules or steps are made into a single integrated circuit module. By doing so, the present invention is not limited to any specific combination of hardware and software.

The above mentioned are only preferred embodiments of the present invention and not used for limiting the present invention. For those skilled in the art, the present invention may have various alterations and changes. Any alterations, equivalent substitution, improvements and so on within the spirit and principle of the present invention shall fall within the scope of the present invention.

1. A method for establishing association between a service network element and a Mobility Management Entity (MME), which is applied to a scenario when a User Equipment (UE) accesses an Evolved Packet System (EPS) network and the service network element needs to establish association with the MME, comprising:
the service network element receiving a message sent by the UE including an information parameter of the MME which is currently serving the UE; and
the service network element acquiring the information parameter of the MME which is currently serving the UE from the message sent by the UE so as to establish association between the service network element and the MME which is currently serving the UE.

2. The method according to claim 1, after the service network element acquires the information parameter of the MME, the method further comprising:
the service network element sending a message including an information parameter of the service network element to the MME;
the MME receiving the message sent by the service network element including the information parameter of the service network element, and acquiring the information parameter of the service network element from the message.

3. The method according to claim 1, wherein
the information parameter of the MME is Globally Unique Temporary UE Identity (GUTI) or identifier information of the MME acquired according to the GUTI.

4. The method according to claim 1, wherein when the message sent from the UE to the service network element is a service registration request message, the service network element sends a message including the information parameter of the service network element to the MME when the service network element receives the service registration request message from the UE or in a service implementing procedure.

5. The method according to claim 1, after the association between the service network element and the MME is established, if there is a change with the MME, the method further comprising:
after receiving an allocated GUTI from the MME which is newly serving the UE, the UE triggering a new registration flow to the service network element to update the association between the service network element and the MME which is newly serving the UE; or
the MME which is newly serving the UE allocating GUTI to the UE and instructing the UE to trigger a new registration flow to the service network element to update the association between the service network element and the MME which is newly serving the UE.

6. The method according to claim 2, after the association between the service network element and the MME is established, if there is a change with the MME, the method further comprising:
information of the service network element being transmitted among MMEs, the MME which is newly serving the UE acquiring and updating the information of the service network element; and/or the MME which is newly serving the UE sending a message to the service network element to update the information of the MME stored in the service network element after acquiring the information of the service network element; or
after receiving an allocated GUTI from the MME which is newly serving the UE, the UE triggering a new registration flow to the service network element to update the association between the service network element and the MME which is newly serving the UE; or
the MME which is newly serving the UE allocating GUTI to the UE and instructing the UE to trigger a new registration flow to the service network element to update the association between the service network element and the MME which is newly serving the UE;
or
after the association between the service network element and the MME is established, if there is a change with the service network element, the method further comprising:
a new service network element acquiring the information parameter of the MME from the old service network element, and sending a message to the MME to update the information parameter of the service network element stored in the MME to the information parameter of the new service network element; or
the UE initiating a new registration procedure to update the association between the new service network element and the MME which is serving the UE.

7. (canceled)

8. The method according to claim 1, wherein
the service network element is an IWF;
the message sent from the UE to the IWF is a registration request message or an update message;
the message sent from the IWF to the MME including the information parameter of the service network element is a registration request message, or a message for requesting to authenticate the validity of the UE, or a message for requesting to register the IWF as a handover anchor point for voice service.

9. A system for establishing association between a service network element and an MME, comprising the MME and the service network element, wherein
the service network element being configured to receive a message sent by the UE including an information parameter of the MME which is currently serving the UE, and acquire the information parameter of the MME from the message so as to establish association between the service network element and the MME which is currently serving the UE.

10. The system according to claim 9, wherein the service network element is further configured to send a message including an information parameter of the service network element to the MME; and the MME is configured to receive the message sent by the service network element including the information parameter of the service network element, and acquire the information parameter of the service network element from the message.

11. The system according to claim 9, wherein the service network element specifically comprises: a receiving unit, an information acquiring unit and a sending unit; wherein
the receiving unit is configured to receive the message sent by the UE including the information parameter of the MME which is currently serving the UE;
the information acquiring unit is configured to acquire the information parameter of the MME; and
the sending unit is configured to send the message including the information parameter of the service network element to the MME.

12. The system according to claim 9, wherein the service network element is an IWF.

13. A User Equipment (UE), configured to send to a service network element a message including an information parameter of an MME which is currently serving the UE.

14. The method according to claim 2, wherein
the information parameter of the MME is Globally Unique Temporary UE Identity (GUTI) or identifier information of the MME acquired according to the GUTI.

15. The method according to claim 2, wherein
the service network element is an IWF;
the message sent from the UE to the IWF is a registration request message or an update message;
the message sent from the IWF to the MME including the information parameter of the service network element is a registration request message, or a message for requesting to authenticate the validity of the UE, or a message for requesting to register the IWF as a handover anchor point for voice service.

16. The method according to claim 3, wherein
the service network element is an IWF;
the message sent from the UE to the IWF is a registration request message or an update message;
the message sent from the IWF to the MME including the information parameter of the service network element is a registration request message, or a message for requesting to authenticate the validity of the UE, or a message for requesting to register the IWF as a handover anchor point for voice service.

17. The method according to claim 4, wherein
the service network element is an IWF;
the message sent from the UE to the IWF is a registration request message or an update message;
the message sent from the IWF to the MME including the information parameter of the service network element is a registration request message, or a message for requesting to authenticate the validity of the UE, or a message for requesting to register the IWF as a handover anchor point for voice service.

18. The method according to claim 5, wherein
the service network element is an IWF;
the message sent from the UE to the IWF is a registration request message or an update message;
the message sent from the IWF to the MME including the information parameter of the service network element is a registration request message, or a message for requesting to authenticate the validity of the UE, or a message for requesting to register the IWF as a handover anchor point for voice service.

19. The method according to claim 6, wherein
the service network element is an IWF;
the message sent from the UE to the IWF is a registration request message or an update message;
the message sent from the IWF to the MME including the information parameter of the service network element is a registration request message, or a message for requesting to authenticate the validity of the UE, or a message for requesting to register the IWF as a handover anchor point for voice service.

20. The method according to claim 14, wherein
the service network element is an IWF;
the message sent from the UE to the IWF is a registration request message or an update message;
the message sent from the IWF to the MME including the information parameter of the service network element is a registration request message, or a message for requesting to authenticate the validity of the UE, or a message for requesting to register the IWF as a handover anchor point for voice service.

21. The system according to claim 10, wherein the service network element is an IWF.
